(19) United States
(12) Patent Application Publication
(10) Pub. No.: US 2020/0168210 A1
(43) Pub. Date: May 28, 2020

(54) DEVICE AND METHOD FOR ANALYZING SPEECH ACT

(71) Applicant: Sogang University Research Foundation, Seoul (KR)

(72) Inventors: Jung Yun SEO, Seoul (KR); Youngjoong KO, Busan (KR); Minyeong SEO, Chunju-si (KR); Juae KIM, Seoul (KR)

(21) Appl. No.: 16/691,968

(22) Filed: Nov. 22, 2019

(30) Foreign Application Priority Data
Nov. 26, 2018 (KR) 10-2018-0147852

(51) Int. Cl. G10L 15/16; G10L 15/22; G06K 9/62; G06F 17/16

(52) U.S. Cl. CPC G10L 15/16; G10L 15/22; G10L 2015/223; G06F 17/16; G06K 9/6215

(57) ABSTRACT

As a speech act analysis device, the speech act analysis device includes: a word similarity calculator that receives an input utterance vector that is vectorized from information on at least one or more words forming an input utterance, and a previous speech act vector that is vectorized from speech act information with respect to a previous utterance of the input utterance, and generates an input utterance similarity vector that reflects similarity between the input utterance vector and the previous speech act vector; a conversation vector generator that generates a conversation unit input utterance vector that is vectorized from information with respect to the input utterance in a conversation including the input utterance by inputting the input utterance similarity vector in a convolution neural network; a conversation similarity calculator that receives a speaker vector that is vectorized from speaker information of the input utterance, and generates a conversation unit input utterance similarity vector that reflects similarity between the conversation unit input utterance vector and the speaker vector; and a speech act classifier that determines a speech act of the input utterance by inputting the conversation unit input utterance similarity vector in a recurrent neural network.

### CROSS-REFERENCE TO RELATED APPLICATION

This application claims priority to and the benefit of Korean Patent Application No. 10-2018-0147852 filed in the Korean Intellectual Property Office on Nov. 26, 2018, the entire contents of which are incorporated herein by reference.

### BACKGROUND

### (a) Field

The present disclosure relates to a method for analyzing a speech act.

### (b) Description of the Related Art

An act of speech refers to an intention of a speaker in speech, and the act of speech analysis refers to determining the act of speech for the speech. Recently, a conversation system that understands a user's speech and generates feedback corresponding to the user's speech has been widely used. Therefore, a speech act analysis to grasp a user's intention in dialogue system is essential.

A conventional speech act analysis method was a mainly rule-based and corpus-based method. A rule-based method is to predefine various rules for determining speech acts and to analyze them using the defined rules. The corpus-based method is to analyze speech acts using a machine learning model, using large corpus data with appropriate pre-labeled speech acts. A statistical classification method, using a support vector machine (SVM), is mainly used.

However, the rule-based method has high performance on data where the rule is defined, but the portability of the rule is low on other data where the rule is not defined. Even in the corpus-based method, the machine learning model requires that humans process and extract domain-dependent qualities, and that there is a big difference in performance between domains.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide a method for comprehending a speaker by analyzing a speech act of an input utterance through a speech act analysis method that hierarchically combines a convolution neural network and a recurrent neural network.

A speech act analysis device according to an exemplary embodiment of the present disclosure includes: a word similarity calculator that receives an input utterance vector that is vectorized from information on at least one or more words forming an input utterance, and a previous speech act vector that is vectorized from speech act information with respect to a previous utterance of the input utterance, and generates an input utterance similarity vector that reflects similarity between the input utterance vector and the previous speech act vector; a conversation vector generator that generates a conversation unit input utterance vector that is vectorized from information with respect to the input utterance in a conversation including the input utterance by inputting the input utterance similarity vector in a convolution neural network; a conversation similarity calculator that receives a speaker vector that is vectorized from speaker information of the input utterance, and generates a conversation unit input utterance similarity vector that reflects similarity between the conversation unit input utterance vector and the speaker vector; and a speech act classifier that determines a speech act of the input utterance by inputting the conversation unit input utterance similarity vector in a recurrent neural network.

The word similarity calculator calculates a similarity score between the input utterance vector and the previous speech act vector, and generates the input utterance similarity vector by using the similarity score.

The conversation vector generator generates the conversation unit input utterance vector by normalizing the input utterance similarity vector into a predetermined size through the convolution neural network.

The conversation similarity calculator calculates a similarity score between the conversation unit input utterance vector and the speaker vector, and generates the conversation unit input utterance similarity vector by using the conversation unit input utterance vector and the similarity score.

The speech act classifier determines at least one or more candidate speech acts with respect to the input utterance by inputting the conversation unit input utterance similarity vector in the recurrent neural network, and determines a speech act of the input utterance among the candidates speech acts based on the recommendation degrees of the candidate speech acts.

A method for a speech act analysis device to determine a speech act according to an exemplary embodiment of the present disclosure includes: receiving an input utterance vector that is vectorized from information on at least one or more words that form an input utterance and a previous speech act vector that is vectorized from speech act information on a previous utterance of the input utterance, and generating an input utterance similarity vector that reflects similarity between the input utterance vector and the previous speech act vector; generating a conversation unit input utterance vector that is vectorized from information on the input utterance in a conversation that includes the input utterance by inputting the input utterance similarity vector in a convolution neural network; receiving a speaker vector that is vectorized from speaker information of the input utterance, and generating a conversation unit input utterance similarity vector that reflects similarity between the conversation unit input utterance vector and the speaker vector; and determining a speech act of the input utterance by inputting the conversation unit input utterance similarity vector in a recurrent neural network.

The generating the input utterance similarity vector includes: calculating a similarity score between the input utterance vector and the previous speech act vector; and generating the input utterance similarity vector by using the input utterance vector and the similarity score.

The generating the conversation unit input utterance vector includes generating the conversation unit input utterance vector by normalizing the input utterance similarity vector to a predetermined size in advance using the convolution neural network.

The generating the conversation unit input utterance similarity vector includes: calculating a similarity score between the conversation unit input utterance vector and the speaker vector; and generating the conversation unit input utterance similarity vector by using the conversation unit input utterance vector and the similarity score.

The determining the speech act of the input utterance includes: determining at least one or more candidate speech acts with respect to the input utterance by inputting the conversation unit input utterance similarity vector in the recurrent neural network; and determining a speech act of the input utterance among the candidate speech acts based on the recommendation degrees of the candidate speech acts.

According to the present disclosure, it is possible to analyze the exact speech act for an input utterance by utilizing both information of an utterance unit and a conversation unit of the input utterance through a speech act analysis method that hierarchically combines a CNN and an RNN hierarchical.

### BRIEF DESCRIPTION OF THE DRAWINGS

FIG. 1 is provided for description of a device for analyzing a speech act according to an exemplary embodiment.

FIG. 2 exemplarily illustrates an input utterance vector and a previous speech act vector.

FIG. 3 shows a method for a speed act analyzing device to determine a speech act of an input utterance.

FIG. 4 illustrates a hardware configuration diagram of a computing device according to an embodiment.

### DETAILED DESCRIPTION OF THE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

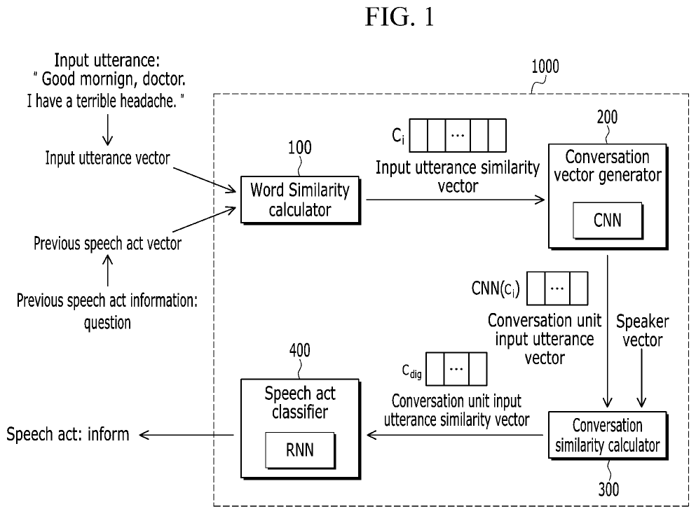

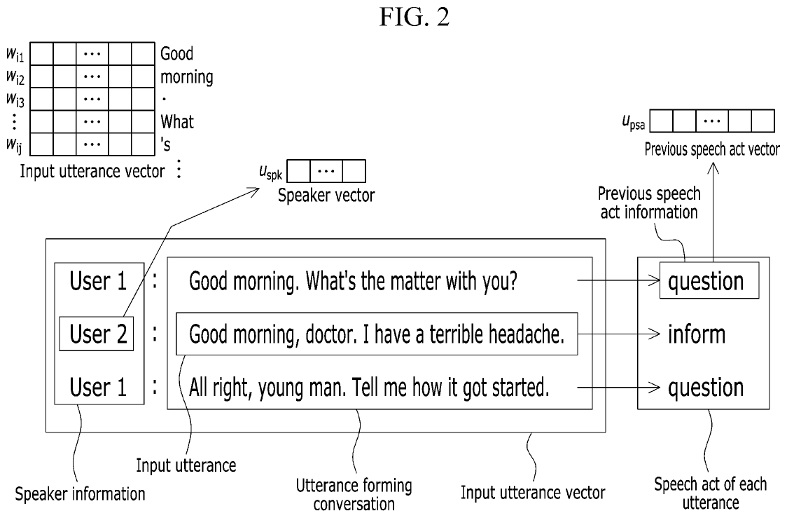

FIG. 1 is provided for description of a device for analyzing a speech act according to an exemplary embodiment, and FIG. 2 exemplarily illustrates an input utterance vector and a previous speech act vector.

Referring to FIG. 1, a speech act analysis device 1000 includes a word similarity calculator 100, a conversation unit speech act vector generator 200, a conversation similarity calculator 300, and a speech act classifier 400.

The word similarity calculator 100, the conversation unit speech act vector generator 200, the conversation similarity calculator 300, and the speech act classifier 400 may be a computing device operated by at least one processor. Here, the word similarity calculator 100, the conversation vector generator 200, the conversation similarity calculator 300, and the speech act classifier 400 may be implemented with one computing device or distributed in separate computing devices. When distributed in the separate computing devices, the word similarity calculator 100, the conversation unit speech act vector generator 200, the conversation similarity calculator 300, and the speech act classifier 400 may communicate with each other through a communication interface. The computing device may be any device capable of executing a software program having instructions written to perform the present disclosure. The computing device may be, for example, a server, a laptop computer, or the like.

Each of the word similarity calculator 100, the conversation unit speech act vector generator 200, the conversation similarity calculator 300, and the speech act classifier 400 may be or have one artificial intelligence model or may be implemented with a plurality of artificial intelligence models. The speech act analysis device 1000 may be one artificial intelligence model or may be implemented with a plurality of artificial intelligence models. Accordingly, one or more artificial intelligence models corresponding to the above-described constituent elements may be implemented by one or more computing devices.

The word similarity calculator 100 receives an input utterance vector that is vectorized from words that form an input utterance and a previous speech act vector that is vectorized from speech act information with respect to a previous utterance of the input utterance.

FIG. 2 exemplarily illustrates an input utterance vector and a previous speech act vector.

Referring to FIG. 2, utterance of “User1”, “Good morning. What's the matter with you?”, utterance of “User2”, “Good morning, doctor. I have a terrible headache.”, and utterance of “User1”, “All right, young man. Tell me how it got started.” respectively correspond to utterances that form a conversation between “User1” and “User2”.

In addition, “User1” and “User2” imply talker information, and a talker vector implies a vector that is vectorized from talker information of an input utterance.

In addition, speech act information of the utterance of “User1”, which is “Good morning. What's the matter with you?”, corresponds to “question”, and speech act information of the utterance of “User2”, which is “Good morning, doctor. I have a terrible headache.”, corresponds to “inform”. Speech act information of the subsequent utterance of “User2”, which is “All right, young man. Tell me how it got started.”, corresponds to “question”. Detailed speech act information described in this specification are terms that are generally used in the technical field of the present disclosure, and detailed description thereof will be omitted.

When the utterance of “User2”, “Good morning, doctor. I have a terrible headache.”, is an input utterance, an input utterance vector may be a vector having a matrix value of information of words that form “Good morning, doctor. I have a terrible headache.”. For example, the input utterance vector may be a vector having information of the word “Good” as one row of vector values and subsequent word information as vector values of each row.

In addition, previous speech act information is speech act information with respect to a previous utterance of the input utterance, and thus “Good morning. What's the matter with you?” corresponds to the previous utterance of “User1”. Further, “question”, which is speech act information of the corresponding utterance, corresponds to previous speech act information.

Meanwhile, the previous speech act vector implies a k-dimension word embedding vector with respect to previous speech act information, and has a predetermined section value. For example, the previous speech act vector may be a word embedding vector with respect to speech act information, and may be a 64-dimensional vector having a minimum value of −0.25 and a maximum value of 0.25. In this case, the previous speech act vector can be initialized to 64 random numbers evenly distributed over the minimum value to maximum value section.

The vector values of the previous speech act vector are undated as a process for determining a speech act of the input utterance proceeds.

The word similarity calculator 100 generates an input utterance similarity vector that reflects similarity between an input utterance vector and a previous speech act vector.

Specifically, the word similarity calculator 100 calculates a similarity score between the input utterance vector and the previous speech act vector, and generates an input utterance similarity vector using the input utterance vector and the similarity score.

$$\begin{matrix}score ( {w}_{ij} , {u}_{psa} ) = {w}_{α} \cdot tanh ( {w}_{w} {w}_{ij} + {w}_{psa} {u}_{psa} + {b}_{utt} ) & ( Equation 1 ) \\ {α}_{ij} = \frac{exp ( score ( {w}_{ij} , {u}_{psa} ) )}{{\sum }_{{j}^{′}} exp ( score ( {w}_{{ij}^{′}} , {u}_{psa} ) )} & ( Equation 2 ) \\ {c}_{i} = {\sum }_{j} {α}_{ij} {w}_{ij} & ( Equation 3 )\end{matrix}$$

Equation 1 to Equation 3 are equations used for the word similarity calculator 100 to calculate the similarity score between the input utterance vector and the previous speech act vector, and to generate an input utterance similarity vector by using the input utterance vector and the similarity score.

In Equation 1, score(wᵢⱼ, uₚₛₐ) denotes a similarity score between an i-th utterance vector and a previous speech act vector of the i-th utterance. wᵢⱼ denotes an utterance vector having j-th word information in the i-th utterance as a vector value. uₚₛₐ denotes a previous speech act vector of i-th utterance vector. wₐ denotes an entire weight value vector. w_{w} denotes a weight value matrix, and wₚₛₐ denotes a weight value matrix with respect to uₚₛₐ. bᵤₜₜ denotes a bias of a similarity score.

wₐ, w_{w}, wₚₛₐ, and bᵤₜₜ are randomly initialized like the previous speech act vector, and are updated as the process for determining a speech act of the input utterance proceeds.

In the exemplary conversations of FIG. 2, the input utterance “Good morning, doctor. I have a terrible headache.” is the second utterance in the conversation, and thus the input utterance vector is w₂ⱼ. In addition, uₚₛₐ implies a vector that is vectorized from the speech act information “question”.

The word similarity calculator 100 multiples the input utterance vector w₂ⱼ and the previous speech act vector uₚₛₐ by weight values that can be learned, respectively, by using Equation 1. Next, score (w₂ⱼ, uₚₛₐ), which is a similarity score between the input utterance vector w₂ⱼ and the previous speech act vector uₚₛₐ, is calculated by multiplying the learned weight value wₐ after through a nonlinear layer. In this case, score (w₂ⱼ, uₚₛₐ) implies similarity scores between word information that forms the input utterance vector w₂ⱼ and the previous speech act vector uₚₛₐ.

In Equation 2, the word similarity calculator 100 classifies similarity scores calculated through Equation 1 by using a softmax function.

In Equation 3, the utterance layer unit attention unit 100 multiplies the word information that forms the input utterance vector by using the classified results as weights. The multiplied values are summed over all word information to generate an input utterance similarity vector for the input utterance. In Equation 3, cᵢ denotes an input utterance similarity vector with respect to an input utterance.

The word similarity calculator 100 may generate an utterance similarity vector for each utterance by repeating the corresponding process for each of the utterances that form conversations.

The generated input utterance similarity vector reflects similarity between an input utterance vector and a pervious speech act vector based on the input utterance vector. That is, since the input utterance similarity vector reflects a reaction between word information included in the input utterance and speech act information of the pervious utterance, the previous speech act information can be used in analysis of a speech act.

The conversation vector generator 200 inputs an input utterance similarity vector to a convolution neural network (CNN), and generates a conversation unit input utterance vector that is vectorized from information on an input utterance in a conversation that includes the input utterance.

Specifically, the conversation vector generator 200 normalizes the input utterance similarity vector with a predetermined size by using the CNN.

In this case, the conversation vector generator 200 performs zero padding so that results passed through a plurality of filters in a convolution layer all have a predetermined size, that is, the results have the same dimension.

For example, the conversation vector generator 200 may specify the number of parameters to be 32 and sizes of the filters to be 3, 4, and 5. In this case, a filter shape may be [filter size (=3, 4, 5), embedding_size=64, 1, num_filter=32]. The filter type generated as described above becomes a weight value in the convolution layer, and the biases may be all be 0.1 as a vector of num_filterlength. The stride may be set to 1, the bias may be added after the stride passed through the convolution layer and then may experience a ReLU function, which is an activation function. In addition, max_pool_size may be 4, and a conversation unit input speech vector may be generated through a pooling layer through max pooling.

The generated conversation unit input utterance vector is a vector representing an input utterance by learning the order of words included in the input utterance. Since the convolution neural network preserves local information of sentences and reflects the order in which words or expressions appear in sentences, the generated conversation unit input utterance vector may vectorize information of the input utterance in the conversation including the input utterance due to similarity with the previous speech act vectors. In addition, the generated conversation unit input speech vector includes information from an input sentence itself.

Meanwhile, the conversation vector generator 200 normalizes each utterance similarity vector to the same predetermined size by using a convolution neural network, and generates conversation unit input utterance vectors, respectively, when utterance similarity vectors of the utterances composing the conversation are generated.

The conversation similarity calculator 300 receives a speaker vector that is vectorized from speaker information of an input utterance. In addition, the conversation similarity calculator 300 calculates a similarity score between the conversation unit input utterance vector and the speaker vector, and generates a conversation unit input utterance similarity vector using the conversation unit input utterance vector and the similarity score.

$$\begin{matrix}score ( CNN ( {c}_{i} ) , {u}_{spk} ) = {w}_{β} \cdot tanh ( {w}_{c} CNN ( {c}_{i} ) + {w}_{spk} {u}_{spk} + {b}_{dig} ) & ( Equation 4 ) \\ {β}_{i} = \frac{exp ( score ( CNN ( {c}_{i} ) , {u}_{spk} ) )}{{\sum }_{{i}^{′}} exp ( score ( CNN ( {c}_{{i}^{′}} ) , {u}_{spk} ) )} & ( Equation 5 ) \\ {c}_{dig} = {\sum }_{i} {β}_{i} CNN ( {c}_{i} ) & ( Equation 6 )\end{matrix}$$

Equation 4 to Equation 6 are equations used for the conversation similarity calculator 300 to calculate a similarity score between the conversation unit input speech vector and the speaker vector, and to generate a conversation unit input utterance similarity vector by using the conversation unit input utterance similarity vector and the similarity score.

In Equation 4, score(CNN(cᵢ), uₛₚₖ) denotes a similarity score between an i-th conversation unit utterance vector and a speaker vector of an i-th utterance. CNN(cᵢ) denotes a conversation unit utterance vector of the i-th utterance. uₛₚₖ denotes a speaker vector that is vectorized from speaker information of the i-th utterance. w_{b} denotes an entire weight value vector. w_{c} denotes a weight value matrix with respect to CNN(cᵢ), and wₛₚₖ denotes a weight value matrix with respect to uₛₚₖ. b_{dig} denotes a bias of a similarity score.

In the example of FIG. 2, “Good morning, doctor. I have a terrible headache.”, which is the input utterance among the utterances that form the conversation is the second utterance in the conversation, and accordingly, a conversation unit input utterance vector of the corresponding utterance is CNN c₂, and uₛₚₖ implies a speaker vector of “user2”.

Through Equation 4, the conversation similarity calculator 300 multiplies the conversation unit input utterance vector CNN(_{c2}) and the speaker vector uₛₚₖ by the weight values w_{c} and uₛₚₖ that can be learned, and then multiples the weight w_{b} that can be learned after passing through the nonlinear layer. In this way, the conversation similarity calculator 300 calculates the score (CNN(c₂), uₛₚₖ), which is the similarity score between CNN(c₂) and the speaker vector uₛₚₖ. In this case, score(CNN(c₂), uₛₚₖ) imply similarity scores between vectors that form CNN(c₂), which is the conversation unit input utterance vectors, and the speaker vector uₛₚₖ.

w_{b}, w_{c}, wₛₚₖ, and b_{dig} are randomly initialized like wₐ, w_{w}, wₚₛₐ, and bᵤₜₜ, and are updated as the process for determining a speech act of an input utterance proceeds.

In Equation 5, the conversation similarity calculator 300 classifies the similarity scores calculated in Equation 4 through a softmax function.

In addition, in Equation 6, the conversation similarity calculator 300 multiplies the results of the conversation by the conversation unit input utterance vector and sums all the conversation unit utterance vectors to generate a conversation unit input utterance similarity vector c_{dig}. In this case, the conversation similarity calculator 300 may generate c_{dig} by processing the resulting value classified by the softmax function through a reduce_sum function.

The speech act determining unit 400 inputs a conversation unit input utterance similarity vector to a recurrent neural network (RNN) to determine the speech act of the input utterance.

Specifically, the speech act determining unit 400 inputs a conversation unit input utterance similarity vector to the recurrent neural network to determine that at least at least one candidate speech acts for the input utterance. Based on the degree of recommendation of candidate speech acts, a speech act of an input utterance is determined among the candidate speech acts.

For example, when the speech act determining unit 400 inputs a conversation unit input utterance similarity vector into the recurrent neural network, a vector for the input utterance that forms the conversation may be output. The output vector by the matrix that reflects the dialogue act information corresponding to the dimensions of the output vector, and pass the softmax. The candidate speech act information corresponding to the vector for the input utterance and probability values for information on each candidate speech act are output. In this case, the speech act determining unit 400 may determine candidate speech act information having the highest probability value among candidate speech act information as speech act information for an input utterance. In the technical field of the present disclosure, a method of outputting candidate speech act information and probability values for each candidate speech act information through a softmax function is a well-known technique, and a detailed description thereof will be omitted.

The recurrent neural network is a model that remembers the previous state and continues to transfer it to the next state, and can effectively reflect the information about the previous input. Therefore, the recurrent neural network that determines a speech act of an input utterance in a conversation unit can accumulate information on the previous speech through a hidden state and finally analyze the speech act on the current utterance.

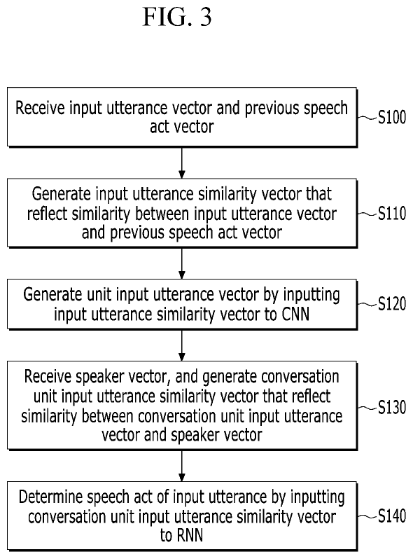

FIG. 3 shows a method for the device for analyzing the speech act to determine a speech act.

In FIG. 3, the same contents as FIG. 1 and FIG. 2 and description thereof will be omitted.

Referring to FIG. 3, the speech act analysis device 1000 receives an input utterance vector that is vectorized from at least one piece of word information that forms an input utterance and a previous speech act vector that is vectorized from the speech act information on the previous utterance of the input utterance (S100).

The speech act analyzing device 1000 generates an input utterance similarity vector reflecting the similarity between the input utterance vector and the previous speech act vector (S110).

Specifically, the speech act analyzing device 1000 calculates a similarity score between the input utterance vector and the previous speech act vector, and generates an input utterance similarity vector using the input utterance vector and the similarity score.

The speech act analysis device 1000 inputs the input utterance similarity vector to a convolution neural network (CNN) to generate a conversation unit input utterance vector that is vectorized from information on an input utterance in a conversation including the input utterance (S120).

In detail, the speech act analysis device 1000 generates the conversation unit input utterance vector by normalizing the same to a predetermined size in advance using the convolution neural network.

The speech act analyzing device 1000 receives a speaker vector that is vectorized from the speaker information of the input utterance, and generates a conversation unit input utterance similarity vector reflecting similarity between the conversation unit input utterance vector and the speaker vector (S130).

In detail, the speech act analyzing device 1000 calculates a similarity score between the conversation unit input utterance vector and the speaker vector, and generates the conversation unit input utterance similarity vector using the conversation unit input utterance vector and the similarity score.

The speech act analyzing device 1000 inputs the conversation unit input utterance similarity vector to a recurrent neural network (RNN) to determine the speech act of the input utterance (S140).

Specifically, the speech act analyzing device 1000 determines the at least at least one candidate speech act for the input utterance by inputting the conversation unit input utterance similarity vector to the recurrent neural network. In addition, a speech act of the input utterance is determined from among the candidate speech acts based on the recommendation degree of the candidate acts.

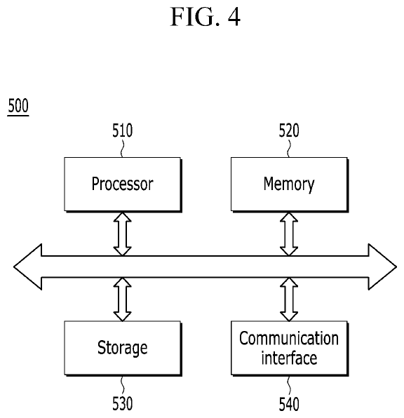

FIG. 4 illustrates a hardware configuration diagram of a computing device according to an embodiment.

Referring to FIG. 4, the word similarity calculator 100, the conversation unit speech act vector generator 200, the conversation similarity calculator 300, and the speech act classifier 400 may execute a program including instructions to perform operations of the present disclosure in a computing device 500 operated by at least one processor.

Hardware of the computing device 500 may include at least one processor 510, a memory 520, a storage 530, and a communication interface 540, which may be connected via a bus. In addition, hardware such as an input device and an output device may be included. The computing device 500 may be installed with an operating system capable of operating the program and various software.

The processor 510 controls the operation of the computing device 500, and it may be a processor of various types for processing instructions included in a program, for example, it may be a central processing unit (CPU), a microprocessor unit (MPU), a microcontroller unit (MCU), a graphics processing unit (GPU), or the like. The memory 520 loads a corresponding program such that the instructions for the operations of the present disclosure are executed by the processor 510. The memory 520 may be, for example, a read only memory (ROM), a random access memory (RAM), or the like. The storage 530 stores various data, programs, and the like required to perform the operations of the present disclosure. The communication interface 540 may be a wired/wireless communication module.

According to the present disclosure, since a speech act analysis model uses a convolution neural network and a recurrent neural network that are combined is hierarchical, accurate speech act analysis can be performed by using both information of an utterance unit and a conversation unit in an input utterance.

The exemplary embodiment of the present disclosure described above is not implemented only by the apparatus and the method, and may also be implemented by a program executing a function corresponding to the configuration of the exemplary embodiment of the present disclosure or a recording medium, in which the program is recorded.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A speech act analysis device comprising:
a word similarity calculator that receives an input utterance vector that is vectorized from information on at least one or more words forming an input utterance, and a previous speech act vector that is vectorized from speech act information with respect to a previous utterance of the input utterance, and generates an input utterance similarity vector that reflects similarity between the input utterance vector and the previous speech act vector;
a conversation vector generator that generates a conversation unit input utterance vector that is vectorized from information with respect to the input utterance in a conversation including the input utterance by inputting the input utterance similarity vector in a convolution neural network;
a conversation similarity calculator that receives a speaker vector that is vectorized from speaker information of the input utterance, and generates a conversation unit input utterance similarity vector that reflects similarity between the conversation unit input utterance vector and the speaker vector; and
a speech act classifier that determines a speech act of the input utterance by inputting the conversation unit input utterance similarity vector in a recurrent neural network.

2. The speech act analysis device of claim 1, wherein
the word similarity calculator calculates a similarity score between the input utterance vector and the previous speech act vector, and generates the input utterance similarity vector by using the similarity score.

3. The speech act analysis device of claim 1, wherein
the conversation vector generator generates the conversation unit input utterance vector by normalizing the input utterance similarity vector into a predetermined size through the convolution neural network.

4. The speech act analysis device of claim 1, wherein
the conversation similarity calculator calculates a similarity score between the conversation unit input utterance vector and the speaker vector, and generates the conversation unit input utterance similarity vector by using the conversation unit input utterance vector and the similarity score.

5. The speech act analysis device of claim 1, wherein
the speech act classifier determines at least one or more candidate speech acts with respect to the input utterance by inputting the conversation unit input utterance similarity vector in the recurrent neural network, and determines a speech act of the input utterance among the candidates speech acts based on the recommendation degrees of the candidate speech acts.

6. A method for a speech act analysis device to determine a speech act, comprising:
receiving an input utterance vector that is vectorized from information on at least one or more words that form an input utterance and a previous speech act vector that is vectorized from speech act information on a previous utterance of the input utterance, and generating an input utterance similarity vector that reflects similarity between the input utterance vector and the previous speech act vector;
generating a conversation unit input utterance vector that is vectorized from information on the input utterance in a conversation that includes the input utterance by inputting the input utterance similarity vector in a convolution neural network;
receiving a speaker vector that is vectorized from speaker information of the input utterance, and generating a conversation unit input utterance similarity vector that reflects similarity between the conversation unit input utterance vector and the speaker vector; and
determining a speech act of the input utterance by inputting the conversation unit input utterance similarity vector in a recurrent neural network.

7. The method for the speech act analysis device to determine the speech act of claim 6, wherein
the generating the input utterance similarity vector comprises:
calculating a similarity score between the input utterance vector and the previous speech act vector; and
generating the input utterance similarity vector by using the input utterance vector and the similarity score.

8. The method for the speech act analysis device to determine the speech act of claim 6, wherein
the generating the conversation unit input utterance vector comprises generating the conversation unit input utterance vector by normalizing the input utterance similarity vector to a predetermined size in advance using the convolution neural network.

9. The method for the speech act analysis device to determine the speech act of claim 6, wherein
the generating the conversation unit input utterance similarity vector comprises:
calculating a similarity score between the conversation unit input utterance vector and the speaker vector; and
generating the conversation unit input utterance similarity vector by using the conversation unit input utterance vector and the similarity score.

10. The method for the speech act analysis device to determine the speech act of claim 6, wherein
the determining the speech act of the input utterance comprises:
determining at least one or more candidate speech acts with respect to the input utterance by inputting the conversation unit input utterance similarity vector in the recurrent neural network; and
determining a speech act of the input utterance among the candidate speech acts based on the recommendation degrees of the candidate speech acts.
